(19) United States
(12) Patent Application Publication
(10) Pub. No.: US 2015/0242433 A1
(43) Pub. Date: Aug. 27, 2015

(54) DATA COMPRESSION APPARATUS AND DATA COMPRESSION METHOD

(71) Applicant: FUJITSU LIMITED, Kawasaki-shi (JP)

(72) Inventor: Noriko Itani, Hadano (JP)

(21) Appl. No.: 14/594,476

(22) Filed: Jan. 12, 2015

(30) Foreign Application Priority Data
Feb. 21, 2014 (JP) 2014-031916

(51) Int. Cl. G06F 17/30

(52) U.S. Cl. CPC G06F 17/30153; G06F 17/30106

(57) ABSTRACT

A memory stores a data string to be compressed, which is partitioned into a plurality of blocks, and further stores a plurality of pieces of address information that respectively represent a plurality of addresses within a first block among the plurality of blocks in an order of the plurality of data strings after being rearranged, the plurality of data strings respectively starting at the plurality of addresses within the first block. A processor searches for, in the first block, a first data string that matches a second data string on the basis of the plurality of pieces of address information. When the first data string is not included in the first block, the processor detects the first data string by referring to a second block among the plurality of blocks. The processor encodes and outputs the second data string on the basis of information of the detected first data string.

### CROSS-REFERENCE TO RELATED APPLICATION

This application is based upon and claims the benefit of priority of the prior Japanese Patent Application No. 2014-031916, filed on Feb. 21, 2014, the entire contents of which are incorporated herein by reference.

### FIELD

The embodiment discussed herein is related to a data compression apparatus and a data compression method.

### BACKGROUND

In recent years, various types of electronic data such as character data, audio data, image data and the like have been processed by computers, and the amount of processed data has been increasing. When such a large amount of data is processed, a storage space of a storage device that stores the data, and the amount of time to transfer the data can be reduced by omitting a redundant portion of the data and compressing the data.

As one of conventional data compression algorithms, LZ77 encoding is proposed (for example, see Non-patent Document 1). With the LZ77 encoding, the amount of data can be reduced by replacing a data string that repeatedly appears in a data string to be compressed with a combination of a position and a length of an identical data string that appeared previously.

FIG. 1 illustrates an example of a data compression process executed with the LZ77 encoding. In an input character string illustrated in FIG. 1, a first character string that matches a second character string starting at an encoding position 101 is searched for, and the second character string is encoded by using a combination of a position and a length of the first character string. An encoding position 101 is shifted toward the posterior as the encoding proceeds.

For example, when a character string “abcdef . . . ”, which starts at the encoding position 101, is encoded, a character string (a matching character string) that matches the character string anterior to the encoding position 101 is “abcdef”. Accordingly, an address of the encoding position 101 “18 (bytes)” relative to a starting position of the matching character string is recognized as a matching position, and the length “6 (bytes)” of the matching character string is recognized as a matching length, so that a code such as (a matching position, a matching length)=(18, 6) is generated. As a result, the character string “abcdef” that starts at the encoding position 101 is replaced with (18, 6).

FIG. 2 is a flowchart illustrating an example of such a data compression process. Initially, the data compression apparatus searches for a character string (a matching character string) that matches a character string starting at an encoding position within a character string anterior to the encoding position (step 201), and checks whether the matching character string has been found (step 202). When the matching character string has been not found (“NO” in step 202), the data compression apparatus counts the length of a portion (a mismatching portion) in which the matching character string has not been found (step 207). Then, the data compression apparatus shifts the encoding position toward the posterior, and repeats the process in and after step 201.

In the meantime, when the matching character string has been found (“YES” in step 202), the data compression apparatus checks whether a character immediately preceding the encoding position is in a mismatching portion (step 203). When the immediately preceding character is in the mismatching portion (“YES” in step 203), the data compression apparatus encodes the character string in the mismatching portion (step 204). Then, the data compression apparatus encodes the character string that starts at the encoding position by using a matching position and a matching length of the matching character string (step 205).

In the meantime, when the immediately preceding character is not in the mismatching portion (“NO” in step 203), the data compression apparatus executes the process in step 205.

Next, the data compression apparatus checks whether the input character string has been encoded (step 206). When the input character string has not been encoded (“NO” in step 206), the data compression apparatus shifts the encoding position toward the posterior, and repeats the process in and after step 201. When the input character string has been successfully encoded (“YES” in step 206), the data compression apparatus terminates the process.

When a mismatching portion is left at the tail end of the input character string in step 206, the data compression apparatus terminates the process after encoding the character string in the mismatching portion.

When an input character string compressed in this way is decompressed, a repetitive character string identical to a matching character string is decompressed by copying the character string from a matching position by a matching length. The character string compressed with the LZ77 encoding can be decompressed by simply copying the character string, so that the decompression process can be executed at high speed.

FIG. 3 illustrates an example of a process of generating a matching position list for searching for a matching character string in the input character string illustrated in FIG. 1 (for example, see Patent Document 1). A matching position list 303 illustrated in FIG. 3 is generated from an order list 302, and stores information for obtaining a matching position of a matching character string, which has recently appeared, from addresses of character strings within an input buffer 301. In this example, character strings (prefixes) of three characters (3 bytes), which respectively start at addresses “0” to “31”, are used as character strings within the input buffer 301.

Initially, the order list 302 is generated by sorting the addresses on the basis of values of prefixes that respectively start at the addresses of the input buffer 301. Next, a matching position of a matching character string that has recently appeared is obtained from a difference between two adjacent addresses among a plurality of addresses corresponding to identical prefixes in the order list 302. Then, information of the obtained matching position is stored at each address of the matching position list 303 that includes addresses “0” to “31” identical to those of the input buffer 301.

For example, a difference “6” between addresses “6” and “12” that correspond to the prefix “abc” in the order list 302 represents the matching position of the prefix “abc” starting at the address “12” of the input buffer 301. Accordingly, the difference “6” is stored at the address “12” of the matching position list 303.

Additionally, a difference “18” between the addresses “3” and “21” that correspond to a prefix “def” in the order list 302 represents a matching position of the prefix “def” starting at the address “21” of the input buffer 301. Accordingly, the difference “18” is stored at the address “21” of the matching position list 303.

Furthermore, if an immediately preceding prefix is different in the order list 302, a difference “0” is stored at a corresponding address of the matching position list 303 in order to indicate that a matching character string is not present.

The matching position list 303 generated in this way is available as a linked list that indicates a plurality of matching positions at each of which a character string identical to a prefix that starts at an encoding position appears, as illustrated in FIG. 4. For example, if the encoding position is at the address “26”, matching positions at which the identical prefix “abc” appears are four positions such as the addresses “18”, “12”, “6” and “0”. By sequentially tracing these matching positions, a character string that matches longer than a character string starting at an encoding position can be obtained. As a result, a compression rate is improved.

Also “merge sort” that generates one list by merging two lists after sorting them in a database operation is known (for example, see Non-patent Document 2).

Additionally, also a data compression method for compressing a data stream partitioned into blocks is known (for example, see Patent Document 2).

Patent Document 1: Japanese Laid-open Patent Publication No. 2001-345710

Patent Document 2: International Publication Pamphlet No. 2009/057459

Non-patent Document 1: Fiala, E., and Greene, D., “Data Compression with Finite Windows”, Communications of the ACM, 32(4), April 1989, 490-505.

Non-patent Document 2: Satish, N et al., “Fast Sort on CPUs and GPUs: A Case for Bandwidth Oblivious SIMD Sort”, Proceedings of the ACM SIGMOD International Conference on Management of Data, 2010, 351-362.

### SUMMARY

According to an aspect of the embodiment, a data compression apparatus includes a memory and a processor.

The memory stores a data string to be compressed, which is partitioned into a plurality of blocks, and stores a plurality of pieces of address information that respectively represent the addresses within a first block among the plurality of blocks in an order of a plurality of data strings after being rearranged, the plurality of data strings respectively starting at the plurality of addresses within the first block.

The processor searches for, in a first block, a first data string that matches a second data string on the basis of the plurality of pieces of address information, and detects the first data string by referring to a second block among the plurality of blocks when the first data string is not included in the first block. The processor encodes and outputs the second data string on the basis of information of the detected first data string.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a data compression process executed with LZ77 encoding.

FIG. 2 is a flowchart illustrating the data compression process executed with the LZ77 encoding.

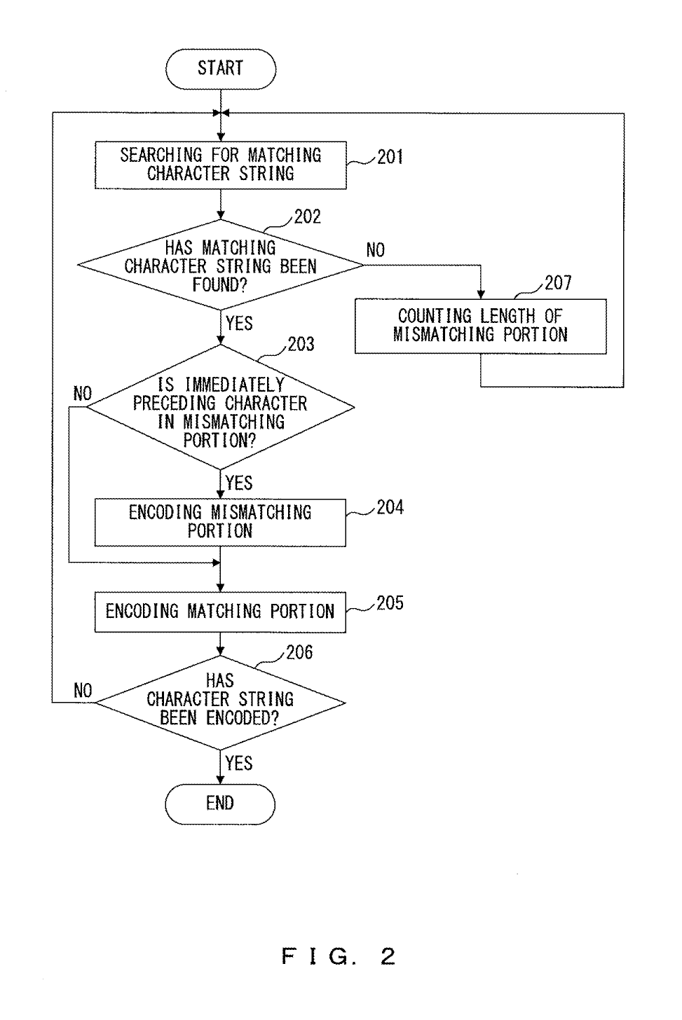

FIG. 3 illustrates a process of generating a matching position list.

FIG. 4 illustrates an input buffer and a matching position list.

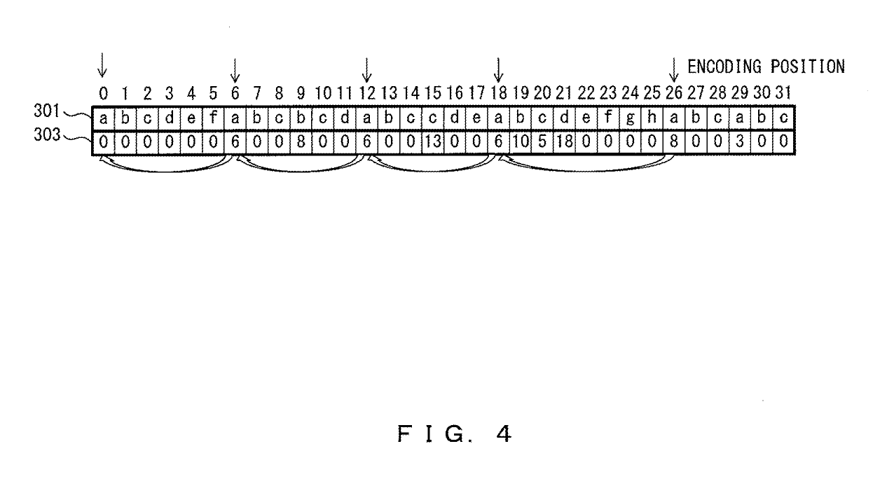

FIG. 5 illustrates a functional configuration of a data compression apparatus.

FIG. 6 is a flowchart illustrating a data compression process.

FIG. 7 illustrates a specific example of the data compression apparatus.

FIG. 8 illustrates a case where a data string to be compressed is partitioned into two blocks.

FIG. 9 illustrates a case where the data string to be compressed is partitioned into four blocks.

FIG. 10 is a flowchart illustrating a matching position list generation process.

FIG. 11A is a flowchart (No. 1) illustrating a specific example of the matching position list generation process.

FIG. 11B is a flowchart (No. 2) illustrating the specific example of the matching position list generation process.

FIG. 12 illustrates a hardware configuration of an information processing device.

### DESCRIPTION OF EMBODIMENT

Embodiments are described in detail below with reference to the drawings.

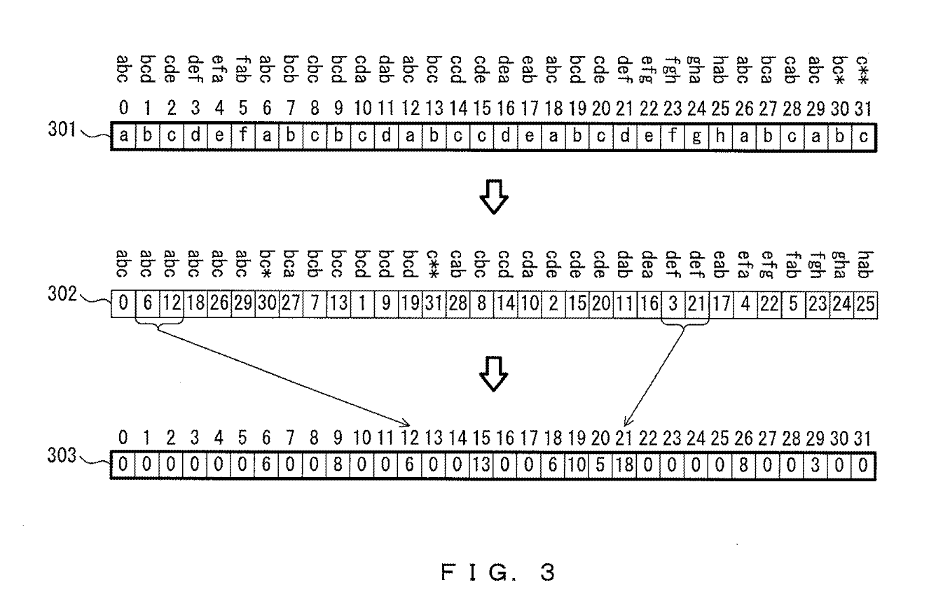

As described above, with the data compression process using the matching position list 303 illustrated in FIG. 3, the order list 302 is generated by sorting addresses on the basis of values of prefixes that respectively start at the addresses of the input buffer 301.

At this time, random accesses are made to the entire input buffer 301 to be sorted. Here, when the size of the input buffer 301 increases, it becomes difficult to store the input buffer 301 and the order list 302 within a primary cache memory provided within a central processing unit (CPU) of a computer. Accordingly, a secondary cache memory having a capacity larger than the primary cache memory is used.

However, an access speed of the secondary cache memory is lower than that of the primary cache memory. Therefore, when addresses are sorted by using the secondary cache memory, the amount of time to generate the order list 302 increases. Accordingly, the high speed performance of random accesses made to the primary cache memory is deteriorated, so that a processing speed is reduced to approximately one-tenth in some cases.

Such a problem is not limited to the case where a data string to be compressed is a characters string, and occurs also in a case where the data string to be compressed is a string of different data such as audio data, image data or the like. Moreover, such a problem is not limited to the data compression process executed with the LZ77 encoding, and also occurs in a different data compression process of encoding a data string that repeatedly appears in a data string to be compressed.

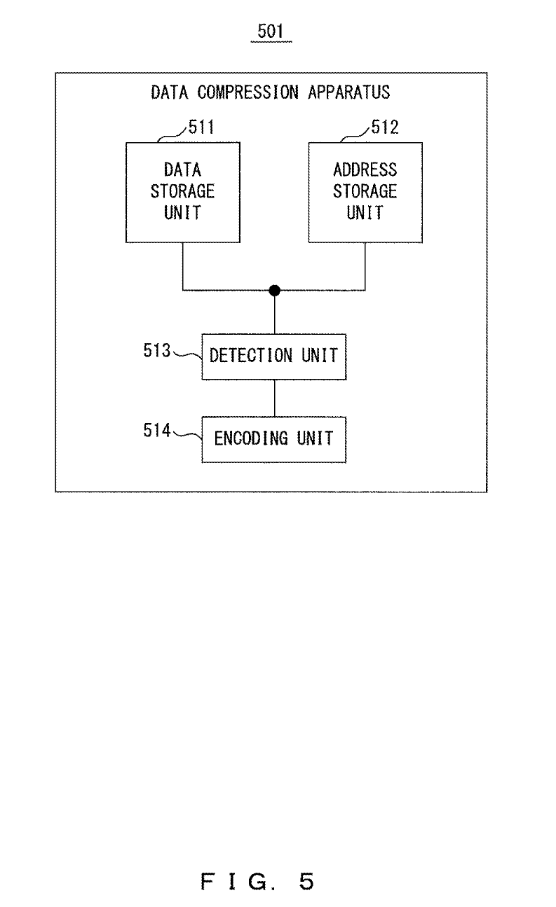

FIG. 5 illustrates an example of a functional configuration of a data compression apparatus according to an embodiment. The data compression apparatus 501 illustrated in FIG. 5 includes a data storage unit 511, an address storage unit 512, a detection unit 513, and an encoding unit 514.

The data storage unit 511 stores a data string to be compressed, which is partitioned into a plurality of blocks. The address storage unit 512 stores a plurality of pieces of address information, which respectively represent addresses within a first block among the blocks, in an order of a plurality of data strings after being rearranged, wherein the plurality of data strings respectively start at the plurality of addresses within the first block.

The detection unit 513 searches for a first data string that matches a second data string on the basis of the plurality of pieces of address information stored in the address storage unit 512, and the encoding unit 514 encodes the second data string on the basis of information of the detected first data string.

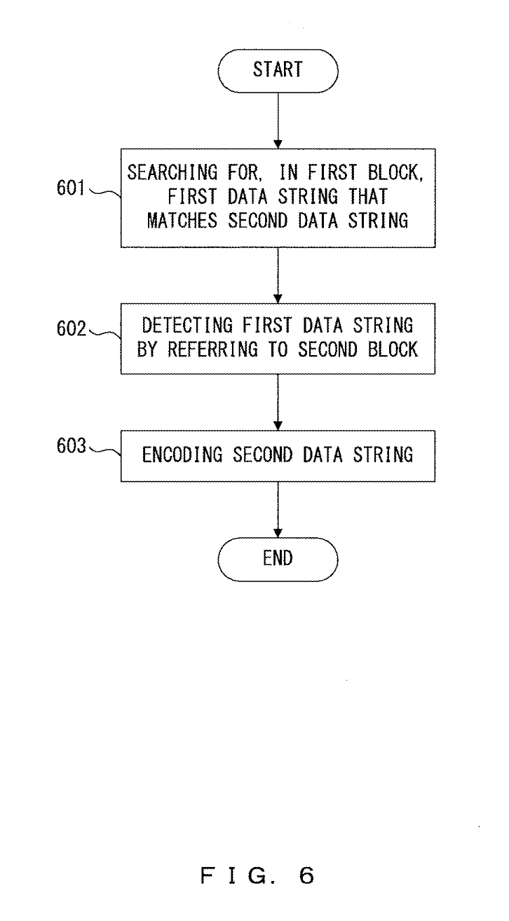

FIG. 6 is a flowchart illustrating an example of a data compression process executed by the data compression apparatus 501 illustrated in FIG. 5.

The detection unit 513 searches for the first data string that matches the second data string among the plurality of data strings within the first block on the basis of the plurality of pieces of address information stored in the address storage unit 512 (step 601). When the first data string is not included in the first block, the detection unit 513 detects the first data string by referring to a second block among the plurality of blocks (step 602).

The encoding unit 514 encodes the second data string on the basis of information of the detected first data string, and outputs the encoded second data string (step 603).

With the data compression apparatus 501 illustrated in FIG. 5, a long data string including a data string that repeatedly appears can be compressed at a higher speed.

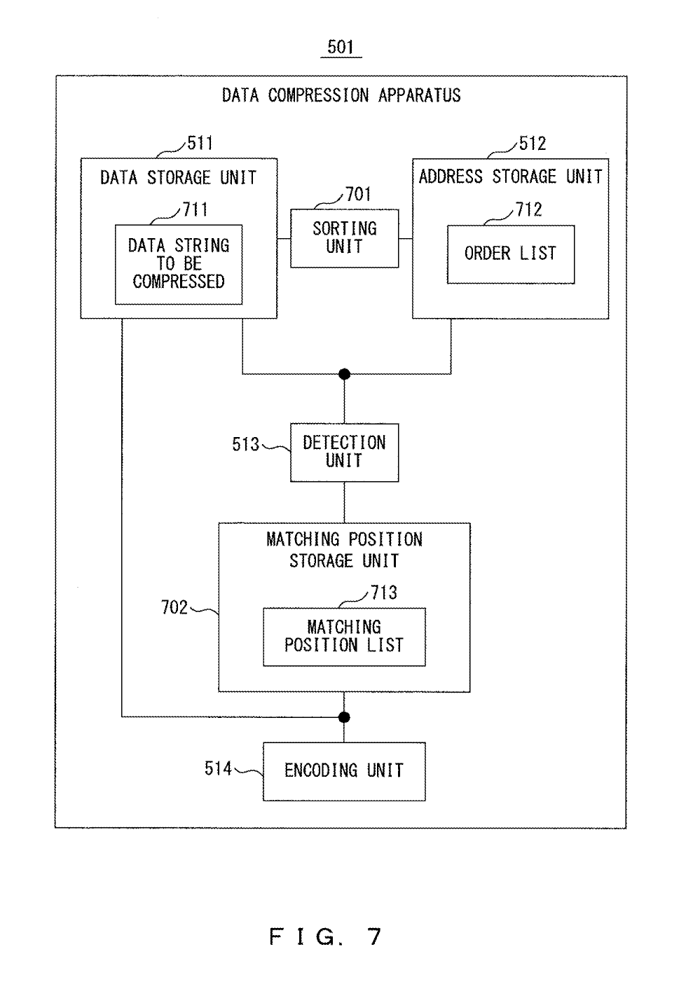

FIG. 7 illustrates a specific example of the data compression apparatus 501 illustrated in FIG. 5. The data compression apparatus 501 illustrated in FIG. 7 includes the data storage unit 511, the address storage unit 512, the detection unit 513, the encoding unit 514, a sorting unit 701, and a matching position storage unit 702.

The data storage unit 511 corresponds to the input buffer 301 illustrated in FIG. 3, and stores a data string to be compressed 711, which is partitioned into a plurality of blocks, in an input order from the anterior toward the posterior.

The sorting unit 701 rearranges data strings that respectively start at addresses within each of the blocks of the data string to be compressed 711 on the basis of content of the data strings in the data storage unit 511. At this time, the sorting unit 701 rearranges the data strings so that a plurality of identical data strings may be mutually adjacent. Then, the sorting unit 701 generates an order list 712 that holds address information of the data strings in an order of the data strings after being rearranged, and stores the generated order list 712 in the address storage unit 512.

The detection unit 513 detects a data string that repeatedly appears within the data string to be compressed 711 on the basis of the address information of the order list 712. Then, the detection unit 513 generates a matching position list 713 holding position information that represents a starting position (a matching position) of a data string (a matching data string) that matches each of the data strings, and stores the generated matching position list 713 in the matching position storage unit 702.

The encoding unit 514 generates compression data by encoding the data string to be compressed 711 on the basis of the position information of the matching position list 713, and outputs the generated compression data.

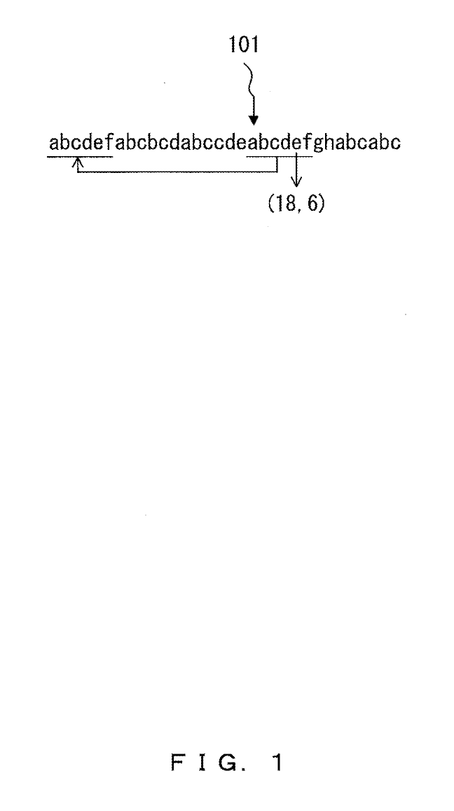

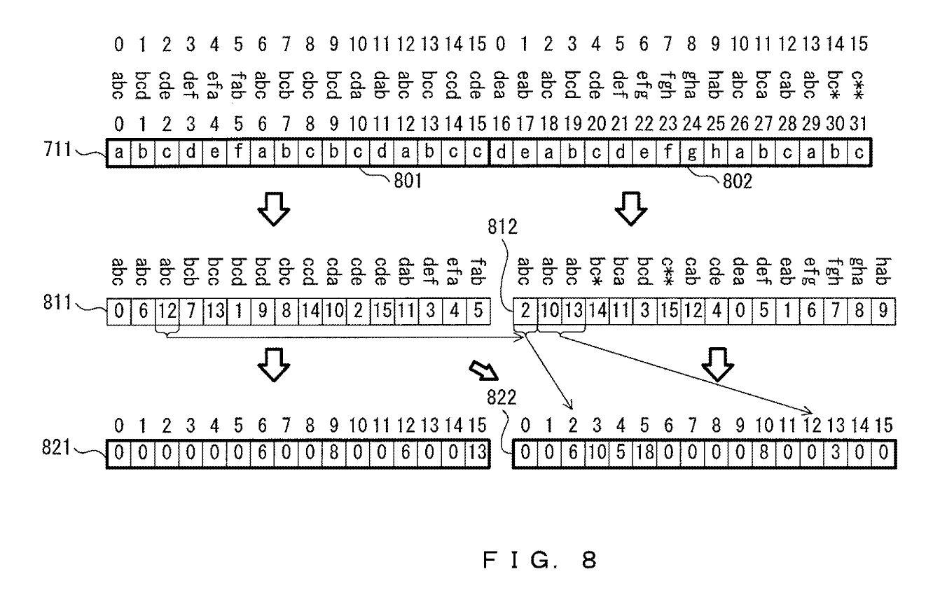

FIG. 8 illustrates an example of a process of generating the matching position list 713 by using the input character string illustrated in FIG. 1 as the data string to be compressed 711. In this example, the data string to be compressed 711 of 32 bytes is stored at addresses “0” to “31” from the anterior to the posterior of the data storage unit 511, and the data string to be compressed 711 is partitioned into two blocks 801 and 802. The size of each of the blocks is 16 bytes.

The block 801 corresponds to the addresses “0” to “15” of the data string to be compressed 711, whereas the block 802 corresponds to the addresses “16” to “31” of the data string. Each of the blocks includes intra-block addresses “0” to “15”.

The sorting unit 701 generates an order list 811 and an order list 812 by sorting 16 prefixes within each of the blocks in an ascending order of 3-byte character strings (prefixes) that respectively start at the intra-block addresses. The order list 811 and the order list 812 correspond to the order list 712 illustrated in FIG. 7. Moreover, the order list 811 and the order list 812 respectively correspond to the block 801 and the block 802, and hold intra-block addresses of starting positions of the prefixes in an order of the prefixes after being sorted.

The detection unit 513 obtains a matching position of a matching character string that has recently appeared from a difference between two adjacent intra-block addresses among a plurality of intra-block addresses corresponding to identical prefixes in each of the order list 811 and the order list 812. When an intra-block address corresponding to an identical prefix is included in both of the order list 801 and the order list 802, the detection unit 513 obtains the matching position on the basis of the intra-block addresses.

Then, the detection unit 513 stores position information that represents the obtained matching position in a matching position list 821 and a matching position list 822, which respectively include the intra-block addresses “0” to “15”. The matching position list 821 and the matching position list 822 correspond to the matching position list 713 illustrated in FIG. 7.

For example, a difference “3” between the intra-block addresses “10” and “13”, which correspond to the prefix “abc” in the order list 812, represents a matching position of the prefix “abc” that starts at the intra-block address “13” of the block 802. Accordingly, the difference “3” is stored at the intra-block address “13” of the matching position list 822.

Additionally, a difference between the intra-block address “12” that corresponds to the most posterior prefix “abc” in the order list 811 and the intra-block address “2” that corresponds to the most anterior prefix “abc” in the order list 812 is “−10”. By converting “−10” into a difference between the addresses within the data string to be compressed 711, “6” is obtained. This difference “6” represents the matching position of the prefix “abc” that starts at the intra-block address “2” of the block 802. Accordingly, the difference “6” is stored at the intra-block address “2” of the matching position list 822.

Furthermore, for only one prefix included in both of the order list 811 and the order list 812, a difference “0” is stored at a corresponding intra-block address of the matching position list 821 and the matching position list 822 in order to indicate that a matching character string is not present. The matching position list 821 and the matching position list 822, which have been obtained in this way, are proved to correspond to the matching position list 303 illustrated in FIG. 3.

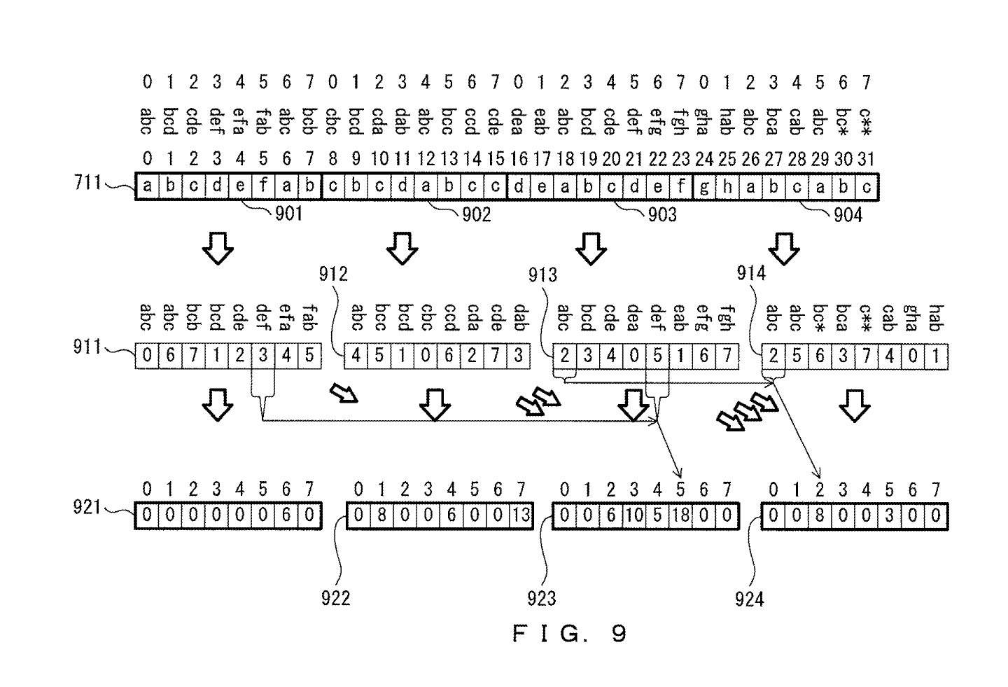

FIG. 9 illustrates another example of the process of generating the matching position list 713 by using the input character string illustrated in FIG. 1 as the data string to be compressed 711. In this example, the data string to be compressed 711 is partitioned into four blocks 901 to 904. The size of each of the blocks is 8 bytes.

The block 901 corresponds to the addresses “0” to “7” of the data string to be compressed 711, whereas the block 902 corresponds to the addresses “8” to “15” of the data string. The block 903 corresponds to the addresses “16” to “23” of the data string to be compressed 711, whereas the block 904 corresponds to the addresses “24” to “31” of the data string. Each of the blocks has intra-block addresses “0” to “7”.

The sorting unit 701 generates order lists 911 to 914 by respectively sorting eight prefixes within the blocks in an ascending order of values of the prefixes of 3 bytes that respectively start at the intra-block addresses. The order lists 911 to 914 correspond to the order list 712 illustrated in FIG. 7. Moreover, the order lists 911 to 914 respectively correspond to the blocks 901 to 904, and hold intra-block addresses at starting positions of the prefixes in an order of the prefixes after being sorted.

The detection unit 513 obtains a matching position of a matching character string, which has recently appeared, from a difference between two adjacent intra-block addresses among a plurality of intra-block addresses corresponding to identical prefixes in each of the order lists 911 to 914. When intra-block addresses corresponding to identical prefixes are included in two order lists, the detection unit 513 obtains the matching position on the basis of the intra-block addresses.

Then, the detection unit 513 stores position information that represents the obtained matching position in matching position lists 921 to 924 respectively including the intra-block addresses “0” to “7”. The matching position lists 921 to 924 correspond to the matching position list 713 illustrated in FIG. 7.

For example, a difference between the intra-block address “2” that corresponds to the prefix “abc” of the order list 913 and the intra-block address “2” that corresponds to the most anterior prefix “abc” in the order list 914 is “0”. By converting “0” into a difference between the addresses in the data string to be compressed 711, “8” is obtained. This difference “8” represents the matching position of the prefix “abc” that starts at the intra-block address “2” of the block 904. Accordingly, the difference “8” is stored at the intra-block address “2” of the matching position list 924.

Additionally, a difference between the intra-block address “3” that corresponds to the prefix “def” of the order list 911 and the intra-block address “5” that corresponds to the prefix “def” of the order list 913 is “2”. By converting “2” into a difference between the addresses in the data string to be compressed 711, “18” is obtained. This difference “18” represents the matching position of the prefix “def” that starts at the intra-block address “5” of the block 903. Accordingly, the difference “18” is stored at the intra-block address “5” of the matching position list 923.

Furthermore, for only one prefix included in all of the order lists 911 to 914, a difference “0” is stored at a corresponding intra-block address of the matching position lists 921 to 924 in order to indicate that a matching character string is not present. The matching position lists 921 to 924, which have been obtained in this way, are proved to correspond to the matching position list 303 illustrated in FIG. 3.

With the process illustrated in FIGS. 8 and 9, even if a long data string to be compressed is input, it is partitioned into blocks of a size that can be sorted within a primary cache memory, so that order lists can be generated by utilizing the high-speed performance of random accesses. Accordingly, the long data string to be compressed can be compressed at a higher speed.

When the input buffer is a 1-byte array, an order list is a 2-byte array. To execute a process of sorting blocks within the primary cache memory, a storage space approximately as three times as a block size is consumed. Accordingly, a maximum block size that can be sorted is conceivable as the size of approximately one-third of the primary cache memory.

For example, when the size of the primary cache memory is 32K bytes, the maximum block size that can be sorted is approximately 10.6K bytes. 1024 bytes or 1024 bytes× (the power of 2) may be used as the block size.

As illustrated in FIGS. 8 and 9, for a matching character string within one block, a matching position is obtained from a difference between two adjacent intra-block addresses within one corresponding order list. When a matching position is not found within a single block, a matching position that straddles blocks is obtained by sequentially referring to blocks immediately anterior and further anterior to the single block. At this time, prefixes can be compared in a descending order of values of the prefixes by comparing the prefixes while referring to an order list of each block from the posterior to the anterior of the list, so that the number of times that each order list is referred to can be reduced to a minimum.

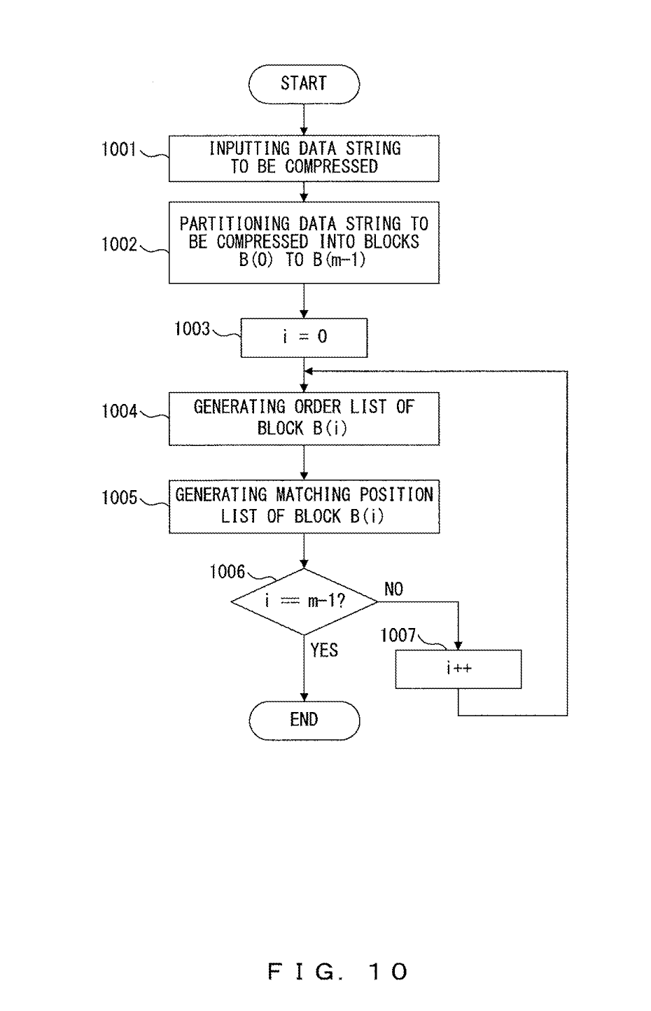

FIG. 10 is a flowchart illustrating an example of a matching position list generation process executed by the data compression apparatus 501 illustrated in FIG. 7.

Initially, the data compression apparatus 501 stores the input data string to be compressed 711 in the data storage unit 511 (step 1001), and partitions the data string to be compressed 711 into m blocks B(0) to B(m−1) (step 1002). m is an integer equal to or larger than 2.

Next, the sorting unit 701 sets, to 0, a variable i for identifying a block (step 1003). Then, the sorting unit 701 generates an order list of the block B(i) by sorting data strings that respectively start intra-block addresses within the block B(i) in an ascending order of values of the data strings (step 1004). By sorting the data strings in the ascending order of the values of the data strings, the data strings are rearranged so that a plurality of identical data strings may be mutually adjacent.

Next, the detection unit 513 generates a matching position list of the block B(i) by searching for a matching data string that matches a data string starting at each address within the block B(i) by referring to i+1 order lists of the blocks B(0) to B(i).

Then, the sorting unit 701 checks whether i is “m−1” (step 1006). When i is not “m−1” (“NO” in step 1006), the sorting unit 701 increments i by 1 (step 1007), and repeats the process in and after step 1004. When i reaches “m−1” (“YES” in step 1006), the data compression apparatus 501 terminates the process.

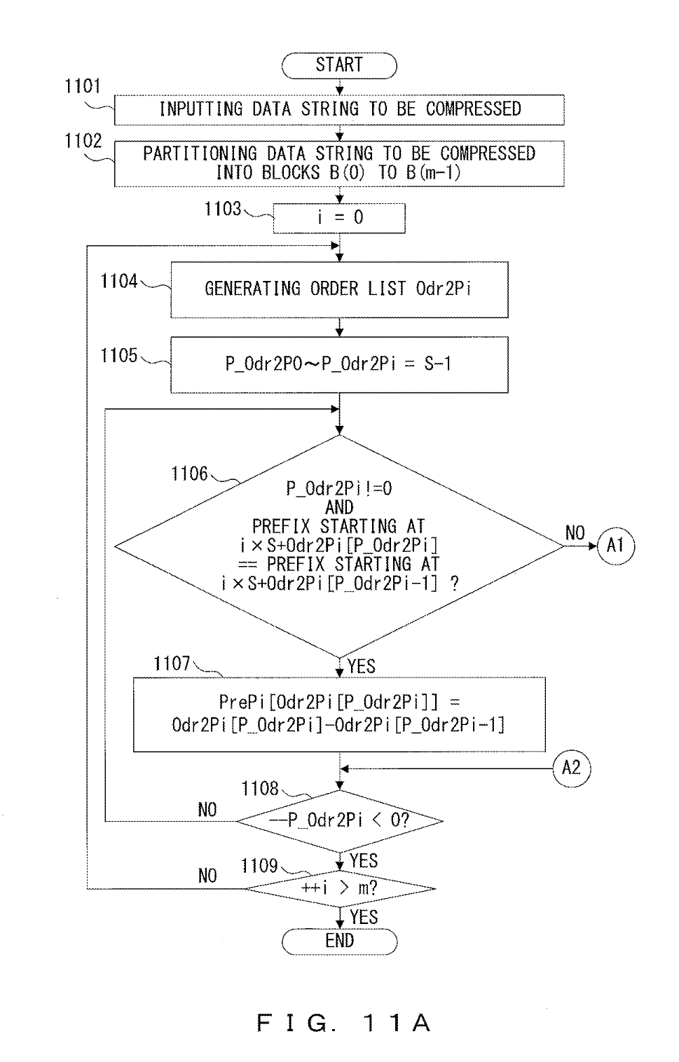

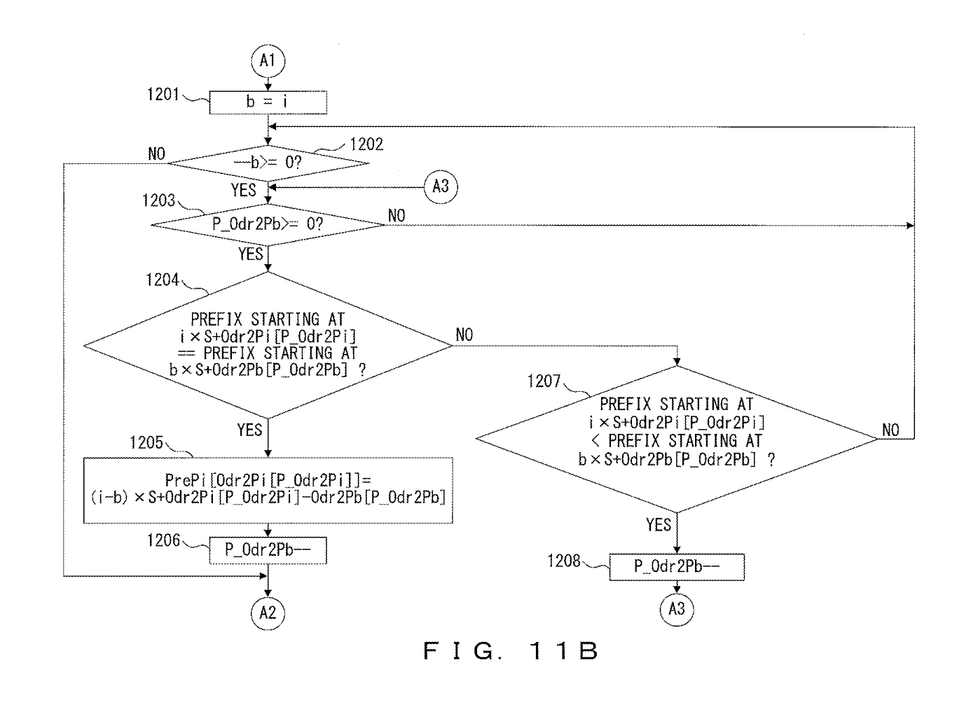

FIGS. 11A and 11B are a flowchart illustrating a specific example of the matching position list generation process illustrated in FIG. 10.

This specific example assumes that a block size, and the size of a prefix of a data string that starts at each address are S bytes and N bytes, respectively. The specific example also assumes that an order list of the block B(i), a matching position list, and a reference pointer that points to a reference position of the order list are Odr2Pi[ ], PrePi[ ] and P_Odr2Pi, respectively.

Odr2Pi[x] represents a value stored at an intra-block address x of the order list Odr2Pi[ ], and PrePi[x] represents a value stored at an intra-block address x of the matching position list PrePi[ ]. When the matching position list generation process is started, all Prepi[x] are initialized to “0”.

The process of steps 1101 to 1103 illustrated in FIG. 11A is similar to that of steps 1001 to 1003 illustrated in FIG. 10. The sorting unit 701 generates an order list Odr2Pi[ ] by sorting prefixes of data strings that respectively start at intra-block addresses within the block B(i) in an ascending order of values of the prefixes (step 1104). By sorting the prefixes in the ascending order, a plurality of identical prefixes mutually become adjacent within the order list Odr2Pi[ ]. When a plurality of identical prefixes are included in the block B(i), the sorting unit 701 sorts the identical prefixes in an ascending order of intra-block addresses.

Next, the detection unit 513 sets, to “S−1”, the reference pointers P_Odr2P0 to P_Odr2Pi (step 1105). As a result, the reference pointers P_Odr2P0 to P_Odr2Pi are set to respectively point to the tail end of the order lists Odr2P0[ ] to Odr2Pi[ ].

Next, the detection unit 513 checks whether the following Condition 1 is satisfied in order to search for a prefix identical to that starting at a prescribed address within the block B(i) (step 1106).

Condition 1: P_Odr2Pi is not “0”, and a prefix starting at an address X(i) of the data string to be compressed 711 matches a prefix starting at an address Y(i).

X(i)=i×S+Odr2Pi[P_{—}Odr2Pi]

Y(i)=i×S+Odr2Pi[P_{—}Odr2Pi−1]

If Condition 1 is satisfied (“YES” in step 1106), the detection unit 513 stores a value of Odr2Pi[P_Odr2Pi]−Odr2Pi[P_Odr2Pi−1] in PrePi[Odr2Pi[P_Odr2Pi]] (step 1107).

Next, the detection unit 513 decrements P_Odr2Pi by 1, and makes a comparison between P_Odr2Pi and “0” (step 1108). If P_Odr2Pi is equal to or larger than “0” (“NO” in step 1108), the detection unit 513 repeats the process in and after steps 1106. By decrementing P_Odr2Pi, a reference position is moved from the posterior to the anterior of the order list Oder2Pi[ ].

When P_Odr2Pi becomes smaller than “0” (“YES” in step 1108), the sorting unit 701 decrements i by 1, and makes a comparison between i and m (step 1109). When i is equal to or smaller than m (“NO” in step 1109), the sorting unit 701 repeats the process in and after step 1104. When i becomes larger than m (“YES” in step 1109), the sorting unit 701 terminates the process. i is incremented and the process in and after step 1104 is repeated, whereby an order list Odr2Pi[ ] of the next block B(i) is generated.

In the meantime, if Condition 1 is not satisfied (“NO” in step 1106), the detection unit 513 sets, to i, a variable b for identifying a sorted block (step 1201 in FIG. 11B). Then, the detection unit 513 decrements b by 1, and makes a comparison between b and “0” (step 1202). If b is smaller than “0” (“NO” in step 1202), the detection unit 513 repeats the process in and after step 1108.

In the meantime, if b is equal to or larger than “0” (“YES” in step 1202), the detection unit 513 makes a comparison between P_Odr2Pb and “0” (step 1203). If P_Odr2Pb is smaller than “0” (“NO” in step 1203), the detection unit 513 repeats the process in and after step S1202.

In the meantime, if P_Odr2Pb is equal to or larger than “0” (“YES” in step 1203), the detection unit 513 executes the process in step 1204. In step 1204, the detection unit 513 checks whether the following Condition 2 is satisfied in order to search for a prefix identical to that starting at a prescribed address within the block B(b) anterior to the block B(i).

Condition 2: A prefix starting at the address X(i) of the data string to be compressed 711 matches a prefix starting at the address X(b).

X(i)=i×S+Odr2Pi[P_{—}Odr2Pi]

X(b)=b×S+Odr2Pi[P_{—}Odr2Pb]

If Condition 2 is satisfied (“YES” in step 1204), the detection unit 513 stores a value of (i−b)×S+Odr2Pi[P_Odr2Pi]−Odr2Pb[P_Odr2Pb] in PrePi[Odr2Pi[P_Odr2Pi]] (step 1205). Then, the detection unit 513 decrements P_Odr2Pb by 1 (step 1206), and repeats the process in and after step 1108. By decrementing P_Odr2Pb, a reference position is moved from the posterior to the anterior of the order list Odr2Pb[ ].

In the meantime, if Condition 2 is not satisfied (“NO” in step 1204), the detection unit 513 makes a comparison between the value of the prefix starting at the address X(i) of the data string to be compressed 711 and that of the prefix starting at the address X(b) (step 1207).

If the value of the prefix starting at the address X(i) is smaller than that of the prefix starting at the address X(b) (“YES” in step 1207), the detection unit 513 decrements P_Odr2Pb by 1 (step 1208), and repeats the process in and after step 1203.

In the meantime, if the value of the prefix starting at the address X(i) is larger than that of the prefix starting at the address X(b) (“NO” in step 1207), the detection unit 513 repeats the process in and after step 1202. At this time, b is decremented in step 1202, so that the block B(b) to be searched is changed to a further anterior block. Accordingly, values anterior to P_Odr2Pb are not referred to among values stored in the order list Odr2Pb[ ], whereby the number of times that the order list Odr2Pb[ ] is referred to is reduced to a minimum.

With such a matching position list generation process, blocks immediately anterior and further anterior to a single block are sequentially referred to when a matching position is not found within the single block, whereby a matching position that straddles blocks is obtained. At this time, prefixes are compared while referring to an order list of each block from the posterior to the anterior, so that the prefixes can be compared in a descending order of values of the prefixes. As a result, the number of times that each order list is referred to is reduced to a minimum.

The configuration of the data compression apparatus 501 illustrated in FIGS. 5 and 7 is merely one example, and some of the components may be omitted or changed depending on a use application or a condition of the data compression apparatus. For example, when the detection unit 513 directly outputs information of a matching position of a detected matching data string to the encoding unit 514 without generating the matching position list 713, the matching position storage unit 702 illustrated in FIG. 7 may be omitted.

The data string to be compressed 711 illustrated in FIGS. 8 and 9 is merely one example. The data string to be compressed 711 may be a string of different data such as audio data, image data or the like. The number of blocks of the data string to be compressed 711 is not limited to two or four, and may be another integer equal to or larger than two.

The flowcharts illustrated in FIGS. 6 and 10 to 11B are merely examples, and some of the processes may be omitted or changed depending on a configuration or a condition of the data compression apparatus. For example, the sorting unit 701 may generate order lists of all blocks prior to the process of step 1003 instead of executing the order list generation process of step 1004 illustrated in FIG. 10 each time i is incremented. Similarly, the sorting unit 701 may generate order lists of all blocks prior to the process of step 1103 instead of executing the order list generation process of step 1104 illustrated in FIG. 11A each time i is incremented.

In step 1202 illustrated in FIG. 11B, the detection unit 513 may make a comparison between the decremented b and a prescribed integer larger than “0” instead of making a comparison between the decremented b and “0”. The process in and after step 1203 is aborted when b becomes smaller than the prescribed integer and the process in and after step 1108 is executed, whereby the number of blocks to be searched can be reduced to speed up the process.

If Condition 2 is not satisfied in step 1204 illustrated in FIG. 11B (“NO” in step 1204), the detection unit 513 may immediately execute the process in and after step 108 without executing the process in step 1207.

In step 1004 illustrated in FIG. 10 and step 1104 illustrated in FIG. 11A, the sorting unit 701 may sort the prefixes in a descending order of the values of the prefixes instead of the ascending order of the values of the prefixes. In this case, the detection unit 513 searches for identical prefixes while moving a reference position of each order list from the anterior to the posterior instead of moving the reference position from the posterior to the anterior. Thus, the prefixes can be compared in the descending order of the values of the prefixes, whereby the number of times that each order list is referred to is reduced to a minimum.

Additionally, the sizes of all blocks do not need to be identical. The sizes of blocks may differ depending on a block. The data compression process illustrated in FIGS. 6 and 10 to 11B is not limited to that executed with the LZ77 encoding. This process is also applicable to a different data compression process for encoding a data string that repeatedly appears in a data string to be compressed.

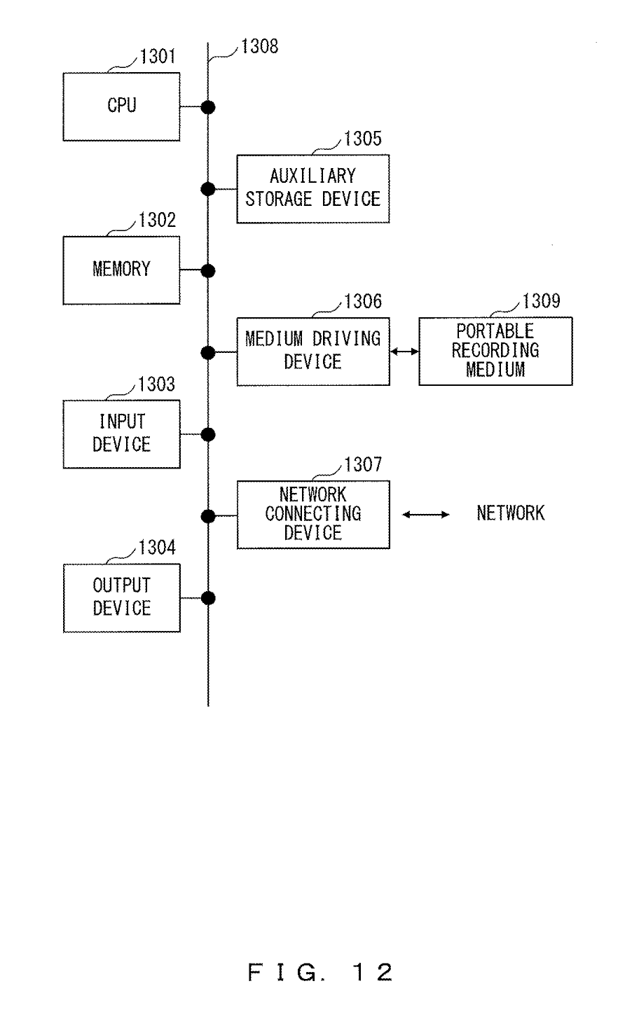

The data compression apparatus 501 illustrated in FIGS. 5 and 7 can be implemented, for example, with an information processing device (a computer) illustrated in FIG. 12.

The information processing device illustrated in FIG. 12 includes a CPU 1301, a memory 1302, an input device 1303, an output device 1304, an auxiliary storage device 1305, a medium driving device 1306, and a network connecting device 1307. These components are interconnected by a bus 1308.

The memory 1302 is a semiconductor memory such as a read only memory (ROM), a random access memory (RAM), a flash memory or the like. The memory 1302 stores a program and data, which are used for a process. The memory 1302 is available as the data storage unit 511, the address storage unit 512 and the matching position storage unit 702, which are illustrated in FIGS. 5 and 7.

The CPU 1301 (processor) operates as the detection unit 513, the encoding unit 514 and the sorting unit 701, which are illustrated in FIGS. 5 and 7, by executing a program, for example, with the use of the memory 1302. When a cache memory is provided within the CPU 1301, the cache memory may be also available as the data storage unit 511, the address storage unit 512 and the matching position storage unit 702.

The input device 1303 is, for example, a keyboard, a pointing device or the like, and is used to input an instruction or information from an operator or a user. The output device 1304 is, for example, a display device, a printer, a speaker or the like, and is used to output an inquiry or an instruction to an operator or a user, and a process result.

The auxiliary storage device 1305 is, for example, a magnetic disk device, an optical disk device, a magneto-optical disk device, a tape device or the like. The auxiliary storage device 1305 may be a hard disk drive or a flash memory. The information processing device can store a program and data in the auxiliary storage device 1305, and can use the program and the data by loading them into the memory 1302.

The medium driving device 1306 drives a portable recording medium 1309, and accesses content of the portable recording medium 1309. The portable recording medium 1309 is a memory device, a flexible disk, an optical disk, a magneto-optical disk or the like. The portable recording medium 1309 may be a compact disk-read only memory (CD-ROM), a digital versatile disk (DVD), a universal serial bus (USB) memory or the like. An operator or a user can store a program and data on the portable recording medium 1309, and can use the program and the data by loading them into the memory 1302.

A computer-readable recording medium for storing a program and data, which are used for a process, is a physical (non-transitory) recording medium such as the memory 1302, the auxiliary storage device 1305, or the portable recording medium 1309.

The network connecting device 1307 is a communication interface that is connected to a communication network such as a local area network, a wide area network or the like, and performs a data conversion associated with a communication. The information processing device can receive a program and data from an external device via the network connecting device 1307, and can use the program and the data by loading them into the memory 1302.

The CPU 1301 can output compression data generated from the data string to be compressed 711, and the auxiliary storage device 1305 can store the compression data. The CPU 1301 can also output the compression data to the medium driving device 1306. The medium driving device 1306 can record the compression data onto the portable recording medium 1309. The CPU 1301 can also output the compression data to the network connecting device 1307. The network connecting device 1307 can transmit the compression data to an external device via a communication network.

The information processing device does not need to include all the components illustrated in FIG. 12. Some of the components may be omitted depending on a use application or a condition of the device. For example, if there is no need to input an instruction or information from an operator or a user, the input device 1303 may be omitted. If there is no need to output an inquiry or an instruction to an operator or a user, and a process result, the output device 1304 may be omitted. Moreover, if the portable recording medium 1309 or a communication network is not used, the medium driving device 1306 or the network connecting device 1307 may be omitted.

When the information processing device is a portable terminal having a call function, such as a smart phone or the like, it may include a device for a call, such as a microphone, a speaker or the like, or may include an imaging device such as a camera.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data compression apparatus, comprising:
a memory configured to store a data string to be compressed, which is partitioned into a plurality of blocks, and to store a plurality of pieces of address information that respectively represent a plurality of addresses within a first block among the plurality of blocks in an order of a plurality of data strings after being rearranged, the plurality of data strings respectively starting at the plurality of addresses within the first block; and
a processor configured to search for, in the first block, a first data string that matches a second data string among the plurality of data strings on the basis of the plurality of pieces of address information, to detect the first data string by referring to a second block among the plurality of blocks when the first data string is not included in the first block, and to encode and output the second data string on the basis of information of the detected first data string.

2. The data compression apparatus according to claim 1, wherein
the memory stores the data string to be compressed in an input order from an anterior to a posterior,
the second block is a block anterior to the first block, and
the processor encodes the second data string by using position information of the first data string.

3. The data compression apparatus according to claim 2, wherein
the memory stores the plurality of pieces of address information in an order of a plurality of values of the plurality of data strings, and
the processor searches for the first data string while referring to the plurality of pieces of address information in a descending order of the plurality of values of the plurality of data strings.

4. The data compression apparatus according to claim 3, wherein
the memory stores a plurality of pieces of address information that respectively represent the plurality of addresses within the second block in an order of a plurality of values of a plurality of data strings that respectively start at the plurality of addresses within the second block, and
the processor searches for the first data string in the second bock while referring to the plurality of pieces of address information that respectively represent the plurality of addresses within the second bock in a descending order of the plurality of values of the plurality of data strings, and detects the first data string by referring to a third block anterior to the second block when a value of a third data string that starts at an address represented by address information at a reference position becomes smaller than a value of the second data string.

5. The data compression apparatus according to claim 1, wherein
the first block has a size where the plurality of data strings respectively starting at the plurality of addresses within the first block are able to be rearranged within a cache memory.

6. A non-transitory computer-readable recording medium having stored therein a program causing a computer to execute a process comprising:
referring to a memory configured to store a data string to be compressed, which is partitioned into a plurality of blocks;
storing in the memory, a plurality of pieces of address information that respectively represent a plurality of addresses within a first block among the plurality of blocks in an order of a plurality of data strings after being rearranged, the plurality of data strings respectively starting at the plurality of addresses within the first block;
searching for, in the first block, a first data string that matches a second data string among the plurality of data strings, and detecting the first data string by referring to a second block among the plurality of blocks when the first data string is not included in the first block; and
encoding and outputting the second data string on the basis of information of the detected first data string.

7. The recording medium according to claim 6, wherein
the memory stores the data string to be compressed in an input order from an anterior to a posterior,
the second block is a block anterior to the first block, and
the encoding the second data string encodes the second data string by using position information of the first data string.

8. The recording medium according to claim 7, wherein
the memory stores the plurality of pieces of address information in an order of a plurality of values of the plurality of data strings, and
the searching for the first data string searches for the first data string while referring to the plurality of pieces of address information in a descending order of the plurality of values of the plurality of data strings.

9. The recording medium according to claim 8, wherein
the memory stores a plurality of pieces of address information that respectively represent the plurality of addresses within the second block in an order of a plurality of values of a plurality of data strings that respectively start at the plurality of addresses within the second block,
the searching for the first data string searches for the first data string in the second block while referring to the plurality of pieces of address information that respectively represent the plurality of addresses within the second block in a descending order of the plurality of values of the plurality of data strings, and
the detecting the first data string detects the first data string by referring to a third block anterior to the second block when a value of a third data string that starts at an address represented by address information at a reference position becomes smaller than a value of the second data string.

10. The recording medium according to claim 6, wherein
the first block has a size where the plurality of data strings respectively starting at the plurality of addresses within the first block are able to be rearranged within a cache memory.

11. A data compression method, comprising:
referring to, by a processor, a memory configured to store a data string to be compressed, which is partitioned into a plurality of blocks;
storing in the memory, by the processor, a plurality of pieces of address information that respectively represent a plurality of addresses within a first block among the plurality of blocks in an order of a plurality of data strings after being rearranged, the plurality of data strings respectively starting at the plurality of addresses within the first block;
searching for, by the processor, in the first block, a first data string that matches a second data string among the plurality of data strings on the basis of the plurality of pieces of address information, and detecting the first data string by referring to a second block among the plurality of blocks when the first data string is not included in the first block; and
encoding and outputting, by the processor, the second data string on the basis of information of the detected first data string.

12. The data compression method according to claim 11, wherein
the memory stores the data string to be compressed in an input order from an anterior to a posterior,
the second block is a block anterior to the first block, and
the encoding the second data string encodes the second data string by using position information of the first data string.

13. The data compression method according to claim 12, wherein
the memory stores the plurality of pieces of address information in an order of a plurality of values of the plurality of data strings, and
the searching for the first data string searches for the first data string while referring to the plurality of pieces of address information in a descending order of the plurality of values of the plurality of data strings.

14. The data compression method according to claim 13, wherein
the memory stores a plurality of pieces of address information that respectively represent the plurality of addresses within the second block in an order of a plurality of values of a plurality of data strings that respectively start at the plurality of addresses within the second block,
the searching for the first data string searches for the first data string in the second block while referring to the plurality of pieces of address information that respectively represent the plurality of addresses within the second block in a descending order of the plurality of values of the plurality of data strings, and
the detecting the first data string detects the first data string by referring to a third block anterior to the second block when a value of a third data string that starts at an address represented by address information at a reference position becomes smaller than a value of the second data string.

15. The data compression method according to claim 11, wherein
the first block has a size where the plurality of data strings respectively starting at the plurality of addresses within the first block are able to be rearranged within a cache memory.
